(19) United States
(12) Patent Application Publication
(10) Pub. No.: US 2026/0343475 A1
(43) Pub. Date: Oct. 29, 2026

(54) FRAMEWORK FOR DETERMINING LOCATION BASED NETWORK COVERAGE VARIATIONS

(71) Applicant: Rakuten Mobile, Inc., Tokyo (JP)

(72) Inventors: Saikat MANDOL, Tokyo (JP); Venkata Satya Sai Yallavula, Tokyo (JP); Rajib Chakrabarti, Tokyo (JP); Md Nurul Amin, Tokyo (JP); Smsamiul Salehin, Tokyo (JP)

(73) Assignee: Rakuten Mobile, Inc., Tokyo (JP)

(21) Appl. No.: 19/189,411

(22) Filed: Apr. 25, 2025

(51) Int. Cl. H04W 64/00; H04B 17/318; H04L 41/16

(52) U.S. Cl. CPC H04W 64/00; H04B 17/318; H04L 41/16

(57) ABSTRACT

Provided are devices, systems, methods for determining if the movement of the user equipment resulted in the degradation of network coverage sessions. According to example embodiments, a device may be configured to determine, based on at least one parameter associated with a location change of a user equipment (UE), that the UE has moved from a first location to a second location that is different from the first location; determine, based on at least one parameter associated with a strength of a signal received by the UE, that the UE has experienced a degradation of network coverage sessions; and based on determining that the UE has moved and that the UE has experienced the degradation of network coverage sessions, determine that the movement of the UE resulted in the degradation of network coverage sessions.

### TECHNICAL FIELD

The present disclosure relates to a framework for determining location-based network coverage variations.

### BACKGROUND

The information disclosed in this background section is only for the enhancement of understanding of the general background of the disclosure and should not be taken as an acknowledgement or any form of suggestion that this information forms the prior art already known to a person skilled in the art.

A telecommunications network consists of various systems and components that interoperate to provide connectivity and services. A user of a telecommunications network may experience instances of poor network coverage (e.g., a sudden signal quality degradation, an unexpected service disruption, a connectivity failure, etc.) on different systems, components, and operations in the telecommunications network due to a variety of reasons. One such reason may be due to changes in the location of the user equipment, which may lead to the user experiencing poor network coverage while using the user equipment.

As a result of experiencing poor network coverage, the user may choose to reduce the volume of their data consumption over time and/or switch to a different telecommunications network operator.

### SUMMARY

Example embodiments of the present disclosure provide devices, systems, methods, and the like, that effectively and efficiently enable determination of whether a user is experiencing poor network coverage, and determine if such experience of poor network coverage is due to a change in the location of the user equipment used by the user.

According to example embodiments, a device may be configured to determine, based on at least one parameter associated with a location change of a user equipment, that the user equipment has moved from a first location to a second location that is different from the first location; determine, based on at least one parameter associated with a strength of a signal received by the user equipment, that the user equipment has experienced a degradation of network coverage sessions; and based on determining that the user equipment has moved and that the user equipment has experienced the degradation of network coverage sessions, determine that the movement of the user equipment resulted in the degradation of network coverage sessions.

According to example embodiments, a method may include: determining, based on at least one parameter associated with a location change of a user equipment, that the user equipment has moved from a first location to a second location that is different from the first location; determining, based on at least one parameter associated with a strength of a signal received by the user equipment, that the user equipment has experienced a degradation of network coverage sessions; and based on determining that the user equipment has moved and that the user equipment has experienced the degradation of network coverage sessions, determining that the movement of the user equipment resulted in the degradation of network coverage sessions.

According to example embodiments, a non-transitory computer-readable recording medium may have recorded thereon instructions executable by a device to cause the device to perform a method. The method may include: determining, based on at least one parameter associated with a location change of a user equipment, that the user equipment has moved from a first location to a second location that is different from the first location; determining, based on at least one parameter associated with a strength of a signal received by the user equipment, that the user equipment has experienced a degradation of network coverage sessions; and based on determining that the user equipment has moved and that the user equipment has experienced the degradation of network coverage sessions, determining that the movement of the user equipment resulted in the degradation of network coverage sessions.

Additional aspects will be set forth in part in the description that follows and, in part, will be apparent from the description, or may be realized by practice of the presented embodiments of the disclosure.

### BRIEF DESCRIPTION OF THE DRAWINGS

Features, aspects, and advantages of embodiments of the disclosure will be described below with reference to the accompanying drawings, in which like reference numerals denote like elements, and wherein:

FIG. 1 illustrates a diagram of an example system configuration, according to one or more example embodiments;

FIG. 2 illustrates a flowchart of a method for determining poor network coverage experience due to changes in user equipment location, according to one or more example embodiments;

FIG. 3 illustrates an example flow of data in a system for determining poor network coverage experience due to changes in user equipment location, according to one or more example embodiments;

FIG. 4 illustrates a flowchart of a method for determining a change in the location of the user equipment based on the use of a clustering algorithm, according to one or more example embodiments;

FIG. 5 illustrates a flowchart of a method for determining a change in the location of the user equipment based on a first parameter associated with a location change of a user equipment, which is obtained by use of the clustering algorithm, according to one or more example embodiments;

FIG. 6 illustrates a flowchart of a method for determining a change in the location of the user equipment based on a second parameter associated with a location change of a user equipment, which is obtained by use of a clustering algorithm, according to one or more example embodiments;

FIG. 7 illustrates a diagram of an example device for implementing one or more example embodiments; and

FIG. 8 illustrates a diagram of an example of implementation environment in which systems and/or method, described herein, may be implemented.

### DETAILED DESCRIPTION

The following detailed description of example embodiments refers to the accompanying drawings. The foregoing disclosure provides illustration and description, but is not intended to be exhaustive or to limit the implementations to the precise forms disclosed. Modifications and variations are possible in light of the above disclosure or may be acquired from practice of the implementations. Further, one or more features or components of one embodiment may be incorporated into or combined with another embodiment (or one or more features of another embodiment). Additionally, the flowchart and description of operations provided below relate to one of the various embodiments. It should be noted that it is possible to make other embodiments that do not exactly match the flowchart and its description. It is understood that in other embodiments one or more operations may be omitted, one or more operations may be added, one or more operations may be performed simultaneously (at least in part).

It will be apparent that systems and/or methods, described herein, may be implemented in different forms of hardware, firmware, or a combination of hardware and software. The actual specialized control hardware or software code used to implement these systems and/or methods is not limited to the described implementations. Thus, the operation and behavior of the systems and/or methods are described herein without reference to specific software code. It is understood that software and hardware may be designed to implement the systems and/or methods based on the description herein.

Even though particular combinations of features are disclosed in the claims and/or in the specification, these combinations are not intended to limit the disclosure of implementations. In fact, many of these features may be combined in ways not specifically recited in the claims and/or disclosed in the specification. Although each dependent claim listed below may directly depend on only one claim, the disclosure of implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]”, “[A] and/or [B]”, or “at least one of [A] or [B]”, are to be understood as including only A, only B, or both A and B.

Expressions such as “at least one processor,” where configured to implement a plurality of operations, execute a plurality of instructions, etc., are to be understood as a single processor implementing the plurality of operations, etc., or each of plural processors implementing at least some (but not necessarily all) of the plurality of operations, etc. In addition, expressions such as “a processor may be configured to perform an operation,” are to be understood as the processor may be configured to execute computer-executable instructions or programming codes to thereby perform an operation. Namely, the instructions or programming codes may be configured to cause the processor to perform an operation.

Reference throughout this specification to “one embodiment,” “embodiment,” “non-limiting exemplary embodiment,” “example embodiment,” or similar language means that a particular feature, structure, or characteristic described in connection with the indicated embodiment is included in at least one embodiment of the present solution. Thus, the phrases “in one embodiment”, “in an embodiment,” “in one non-limiting exemplary embodiment,” and similar language throughout this specification may, but do not necessarily, all refer to the same embodiment.

Further, the described features, advantages, and characteristics of the present disclosure may be combined in any suitable manner in one or more example embodiments. One skilled in the relevant art will recognize, in light of the description herein, that the present disclosure can be practiced without one or more of the specific features or advantages of a particular embodiment. In other instances, additional features and advantages may be recognized in certain embodiments that may not be present in all embodiments of the present disclosure.

In the present disclosure, specific tasks may be performed using Artificial Intelligence and/or Machine Leaning (AI/ML) models. An AI/ML model is a model generated using one or more AI technologies, one or more ML algorithm or both, and generates output data based on input data. This output data is used to perform tasks. Tasks performed using AI/ML models include those generally referred to as intellectual tasks, such as classification, prediction, natural language processing, etc.

Although AI and ML are explained separately, ML is a technology included in AI. In ML, instead of being explicitly programmed for a specific task, systems can improve their performance over time by identifying patterns and making inferences from training data. Typically, the generation of ML models includes data collection, model training, and model inference. Data collection involves gathering and preprocessing data to be used for training and inference. Model training involves developing and validating models using the collected data. Model inference involves applying the trained models to new data to generate new output data and perform tasks.

Machine learning includes various types of learning methods such as supervised learning, unsupervised learning, reinforcement learning, semi-supervised learning, self-supervised learning, transductive learning, transfer learning, meta learning, and the like. These types of learning methods can be appropriately selected according to the embodiments. Unless otherwise specified, the application of types not mentioned in this description is not precluded. Additionally, the structure of ML models may vary depending on the embodiments and learning methods, and is not limited to the methods disclosed. Furthermore, ML includes deep learning, which uses models that include neural networks. Deep learning models may include, for example, deep neural networks (DNNs), convolutional neural networks (CNNs), etc.

It should be noted that the AI/ML models presented hereinafter are examples and are not limited to the illustrated AI/ML models. They can be modified or altered by using different AI or ML algorithms. The configuration of the neural network is not limited to the configuration disclosed in the present disclosure and can be modified.

As described above, a user (e.g., subscriber) of a telecommunications network may experience poor network coverage resulting from a change of location, and may therefore choose to reduce the volume of their data consumption over time and/or switch to a different telecommunications network operator. It is therefore important for telecommunications network operators (or mobile network operators) to be able to determine if a user of the telecommunications network is experiencing poor network coverage and the cause of that poor network coverage (specifically, if it is due to a change in location of the UE) in order to take appropriate measures to expeditiously rectify potential faults in telecommunication networks to ensure that the user continues to subscribe to the telecommunications services provided by the telecommunications network operators. In this regard, as will be described below, the determination of the causes of poor network coverage in the related art is suboptimal.

Specifically, when a user reports a complaint about experiencing poor network coverage, the telecommunications network operator should pinpoint the cause of such adverse issues faced by the user in order to rectify it. The cause, however, may be due to a myriad of reasons, such as behavioral and location based reasons.

In particular, in the related art, there may be techniques available for determining that a user equipment is experiencing a degradation of network coverage based on parameters associated with the signal strength received by the user equipment.

However, when there is a deterioration of network coverage experienced by the user, there is a lack of an analysis framework available to the telecommunications network operator for pinpointing whether or not such bouts of poor network coverage experienced by the user are due to location-based reasons, such as a change in the location of the user equipment used by the user.

Accordingly, in the related art, when a user experiences extended service disruptions and reports the same, there is a lack of a framework for directly correlating the user reported issues of poor network coverage to a change in location of the user equipment, thereby hindering network operators from performing efficient troubleshooting of the problem and thus potentially resulting in reduced user satisfaction.

Example embodiments of the present disclosure, as described in the following, provide systems, devices, methods and the like, that effectively and efficiently provide a framework for determining that changes in user equipment location resulted in poor network coverage experience by the user equipment, and ultimately address the shortcomings of the related art.

Specifically, example embodiments of the present disclosure provide systems, devices, methods, and the like, that receive data of a user equipment, and perform operations on the data, such as via the use of a clustering algorithm, to determine whether or not the poor network coverage experienced by the user is due to a change in location of the user equipment used by the user.

Accordingly, example embodiments enable telecommunications network operators to effectively and efficiently determine if a user is experiencing poor network coverage due to a change in the location of the user equipment used by the user, thereby bringing several commercial advantages, such as enabling telecommunications network operators to plan appropriate strategies for subscriber churn reduction and retention, revenue optimization, competitive differentiation, enterprise and business-to-business (B2B) solutions, regulatory and compliance benefits, as well as, technical advantages, such as enabling root cause analysis of data consumption patterns, improved network planning and optimization, personalized network experience, AI-driven decision support for customer service, and enhanced predictive modelling.

It is contemplated that features, advantages, and significances of example embodiments described hereinabove are merely a portion of the present disclosure, and are not intended to be exhaustive or to limit the scope of the present disclosure. Further descriptions of the features, components, configuration, operations, and implementations of the example embodiments of the present disclosure are provided in the following.

### Example System Architecture

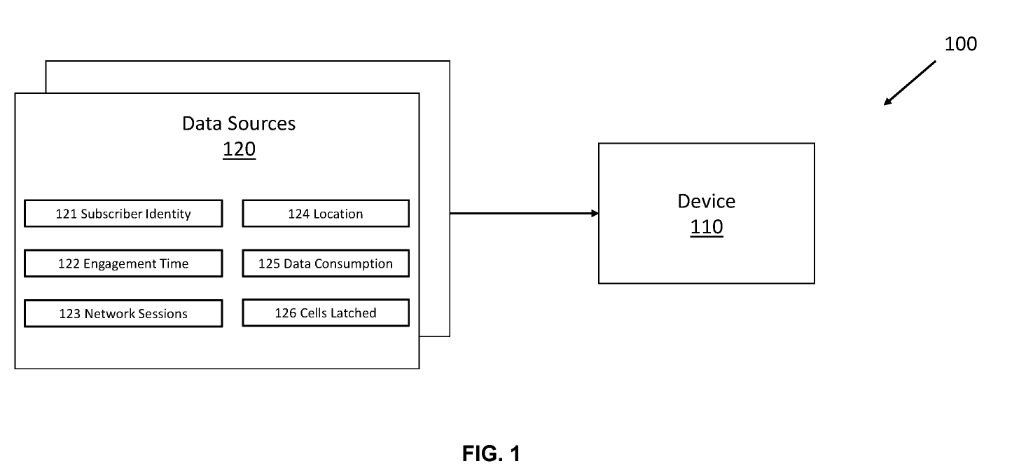

FIG. 1 illustrates a diagram of an example system configuration 100, according to one or more example embodiments. As shown in FIG. 1, the system configuration 100 may include a device 110 and one or more data sources 120. The one or more data sources 120 may include any data storage that stores mobile network data (e.g., network telemetry data collected from user equipment, base stations and other Radio Access Network (RAN) nodes, core network nodes, etc.). For example, the data sources 120 may include one or more databases, data lakes, cloud storage solutions, etc., and/or may be included in a Business Support System (BSS), Operational Support System (OSS), etc. The data may be telemetry, key performance indicator (KPI), metric, etc., data, and may be real-time data, batch collected data, etc. The device may be any computing device, such as an OSS device, a BSS device, a client terminal, a server device, a core network device, a network function, etc.

It is contemplated that the system configuration 100 in FIG. 1 is merely an example and the configuration of the system and components therein may vary according to the requirements or implementations. For instance, in some example embodiments, multiple devices may be implemented, and the like, without departing from the scope of the present disclosure.

Generally, device 110 may be configured to receive data of a user equipment (e.g., subscriber identity 121, engagement time 122, network sessions 123, location data 124, data consumption data 125, cell latched data 126, etc.) from the data sources 120, determine, based on the received data, if a user is experiencing poor network coverage and if the user equipment has moved from one location to another, and determine if such experience of poor network coverage is a result of the movement of the user equipment from one location to another. In this regard, descriptions such as “a device may be configured to perform an operation”, and the like, may be interpreted as “a device (or a hardware component) may execute computer-readable instructions or programming codes to perform an operation associated therewith”.

Specifically, in example embodiments, the device 110 may receive, from the data sources 120, location data of a user equipment of a subscriber, which may include geographical coordinates comprising latitude and longitude of the user equipment over a period of time. The device 110 may then input the received location data into a machine-learning based clustering algorithm to form at least two clusters of data. The device 110 is then configured to calculate parameters of the at least two clusters of data, which includes confidence factors of the at least two clusters, a product of the confidence factors, and a distance between the centroid of a first and second cluster in the at least two clusters. Based on the calculated parameters, the device 110 is able to determine if the user equipment has moved from one location to another. Further, in example embodiments, the device 110 may be configured to receive further data from data sources 120, which may include data associated with a strength of a signal experienced by the user equipment over the same period of time, and determine based on the calculated parameters and the received further data, as to whether or not the user equipment experienced a decrease in signal strength due to the movement of the user equipment from one location to another. The data received from the data sources 120 may be received on a subscriber or user equipment basis, for a particular subscriber and/or user equipment.

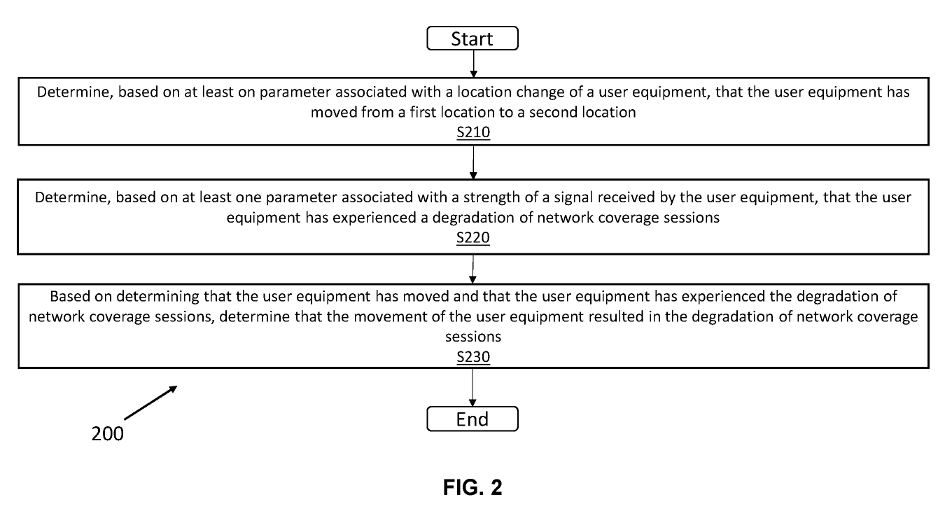

Ultimately, example embodiments of the present disclosure may provide an effective and efficient framework to enable determination of whether a user is experiencing poor network coverage, and determine if such experience of poor network coverage is due to a change in the location of the user equipment used by the user. It is contemplated that features, advantages, and significances of example embodiments described hereinabove with reference to FIG. 1 are merely a portion of the present disclosure, and are not intended to be exhaustive or to limit the scope of the present disclosure. Further descriptions of example methods and operations associated with the components of system configuration, are provided below with reference to FIGS. 2 - 6.

### Example Methods and Operations

As described above, the device 110 in FIG. 1 may be configured to operate with data sources 120 and perform one or more methods and operations to determine if a user is experiencing poor network coverage due to changes in the location of the user equipment. In the following, descriptions of example methods and associated operations are provided.

One or more operations (and the data involved therein) may be similar to those described above with reference to FIG. 1, thus it may be understood that the above-described operations and data may be similarly applied to the operations described hereinbelow (unless stated otherwise).

For descriptive purposes, the methods and operations may be mainly described as being performed by one or more specific components, although it can be understood that, in actual implementations, another related component(s) may perform similar/related operations, without departing from the scope of the present disclosure. For instance, an operation of the device that implements the clustering algorithm receiving data from a data source may indicate or suggest an operation of the data source providing the data to the device that implements the clustering algorithm, and the like.

According to example embodiments, one or more components of the system configuration 100 in FIG. 1 may be implemented in one or more devices or hardware components, and one or more methods and operations described herein below may be performed by the one or more devices.

FIG. 2 illustrates a diagram of a method 200 for determining poor network coverage experience due to the movement of the user equipment from one location to another location.

Referring to FIG. 2, at operation S210, a determination may be made, based on at least one parameter associated with a location change of a user equipment, as to whether the user equipment has moved from a first location to a second location. The at least one parameter associated with the location change of the user equipment may include a confidence factor product and a distance between a centroid of a first cluster of data and a second cluster of data.

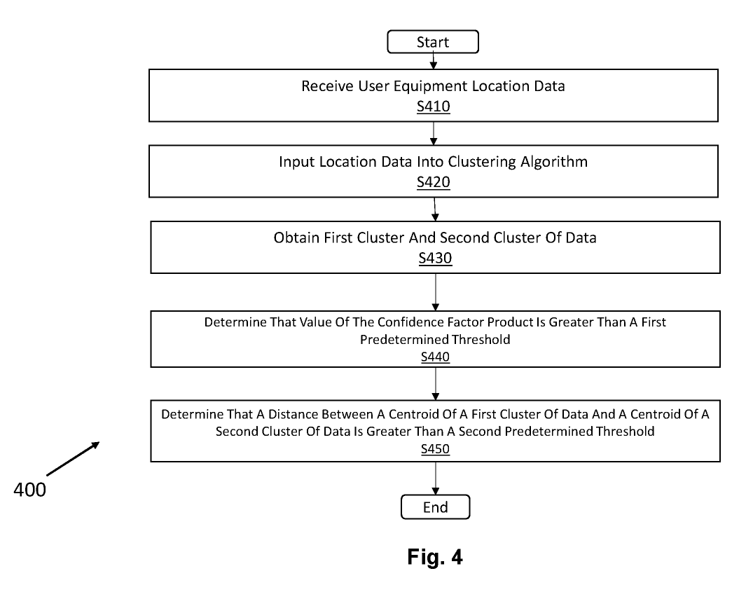

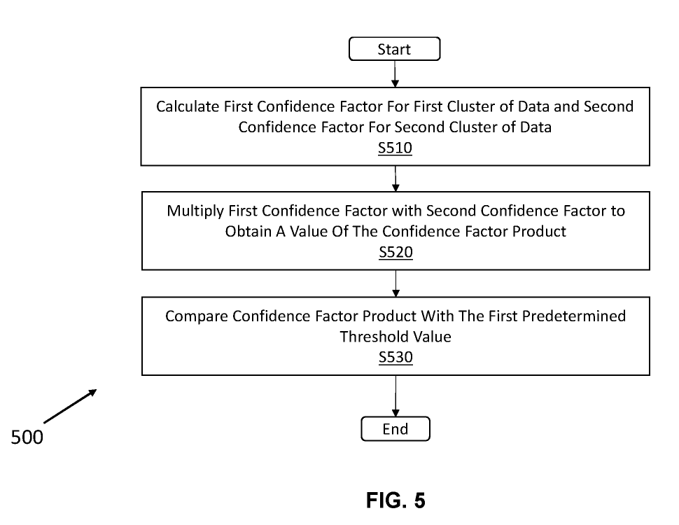

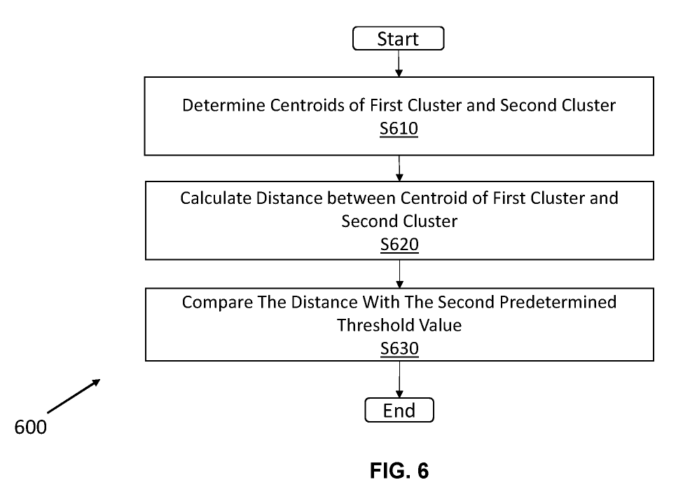

The confidence factor product and the distance between the centroid of the first cluster of data and the second cluster of data may be obtained by use of a clustering algorithm, which will be described in further detail with reference to FIGS. 4 - 6 below. Additionally, details on the method for determining that the user equipment has moved from a first location to a second location, based on the at least one parameter, will be described with reference to FIGS. 5 and FIG. 6 and below.

At operation S220, a determination may be made, based on at least one parameter associated with a strength of a signal received by the user equipment, as to whether the user equipment has experienced a degradation of network coverage sessions. The at least one parameter associated with a strength of the signal received by the user equipment may include a first percentage associated with sessions where the strength of a signal experienced by the user equipment at a first location is below -116dBm , and a second percentage associated with sessions where the signal strength experienced by the user equipment at a second location different from the first location is below -116dBm.

In this regard, the first percentage may be interpreted as a percentage of poor network coverage sessions experienced by the user equipment at a first location before a change in location of the user equipment, and the second percentage may be interpreted as a percentage of poor network coverage sessions experienced by the user equipment at a second location after a change in location of the user equipment.

Further, at operation S220, it may be determined that the user equipment has experienced a degradation of network coverage sessions, by determining if the second percentage is greater than the first percentage.

It may be understood that operation S220 is not limited to be performed after operation S210, and that operation S220 can be reversed or performed simultaneously in relation to operation S210. Further, it may be understood that either of operations S210 and S220 may be performed based on or triggered by an affirmative determination in the other or operations S210 and S220 (e.g., the determination of whether the user equipment has experienced degradation of network coverage sessions may be made only if it is determined that the user equipment has changed location, or vice versa). Further, it may be understood that the collection of relevant data from data sources 120 (as well as performance of the method) may be conditioned on a determination that the corresponding user (or subscriber) has reduced their volume of data consumption (e.g., by at least a predetermined amount) over time (e.g., a predetermined time period) and/or has ended their subscription or switched to a different telecommunications network operator.

The method then proceeds to operation S230. At operation S230, a determination may be made as to whether the movement of the user equipment from the first location to a second location different from the first location, has resulted in the degradation of the network coverage sessions.

The determination that the movement of the user equipment resulted in the degradation of network coverage sessions at operation S230 may be based on the results of the determinations performed at operations S210 and S220.

That is, based on the determination that the user equipment has moved from first location to a second location at operation S210, and based on the determination that user equipment has experienced a degradation of network coverage sessions at operation S220, it may be determined at operation S230 that the movement of the user equipment resulted in the degradation of network coverage sessions.

According to example embodiments, the method may further include one or more operations that are triggered by determining that the user equipment experienced a degradation of network coverage sessions due to location change. For example, the determination may cause the device to generate and/or output an alarm or notification of the degradation caused by location change (or of the second location at which the degradation is experienced). For example, the alarm or notification may be output to an OSS or a BSS device or user. The alarm or notification may trigger a manual and/or automated process for coverage gap or poor coverage resolution (e.g., allocation of additional network resources, adjustment of hardware (e.g., antenna configuration, tilt, etc.), adjustment of power or energy settings, deployment of cell sites, etc.), a manual and/or automated process for churn cause analysis and/or resolution, etc.

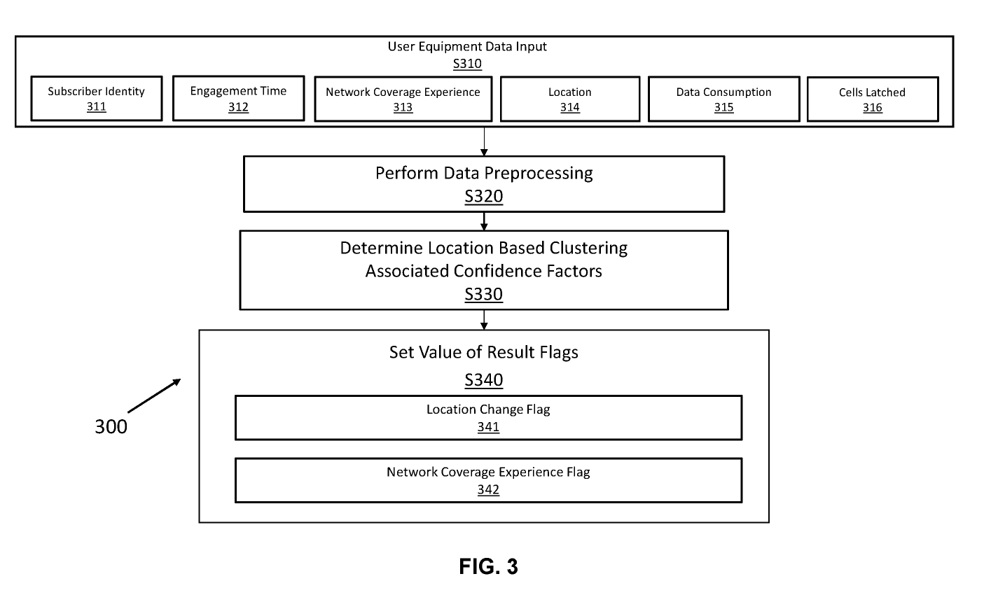

FIG. 3 illustrates an example use case 300 in which one or more operations in method 200 may be implemented, according to one or more example embodiments. One or more operations of example use case 300 may be implemented by device 110, as described above with reference to FIG. 1, thus redundant descriptions associated therewith may be omitted below for conciseness.

Referring to FIG. 3, in example embodiments, at operation S310, the device may be configured to receive user equipment data. User equipment data may include data associated with a user equipment such as, Subscriber Identity 311, Engagement Time 312, Network Coverage Experience 313, Location 314, Data Consumption 315 and Cells Latched 316.

In example embodiments, the user equipment data may be received from data sources 120, as described above with reference to FIG. 1, thus redundant descriptions associated therewith may be omitted below for conciseness. The use case may then proceed to operation S320.

At operation S320, in example embodiments, the device may be configured to preprocess the received user equipment data. The preprocessing of user equipment data may include operations such as data formatting and feature engineering of the user equipment data received at operation S310. The use case may then proceed to operation S330.

At operation S330, in example embodiments, the device may be configured to process the user equipment data received at operation S310 to determine parameters associated with the user equipment data. The processing of the user equipment data may include inputting the user equipment data received at operation S310 into clustering algorithms, in order to obtain clusters of data. Parameters associated with the clusters of data may be determined by the device.

In example embodiments, the clustering algorithm may be a location clustering algorithm such as, a Density-Based Clustering of Applications with Noise (DBSCAN), and the like. Further, the computed parameters associated with the clusters of data may include location-based clustering-associated confidence factors.

In example embodiments, based on user equipment data received at operation S310, the preprocessing of at operation S320 and the parameters associated with the user equipment data that are determined at operation S330, the device may be configured to set values of result flags at operation S340.

In example embodiments, the result flags at operation S340 may include a location change flag 341 and a network coverage experience flag 342. The device may set the location change flag 341 to a predetermined value, if it is determined that the user equipment has moved from one location to another. For example, if it is determined that the user equipment has moved from one location to another, the device may set the value of location change flag 341 to 1. Similarly, in example embodiments, if it is determined that the user equipment has not moved from one location to another, the device may set a value of the location change flag 341 to 0.

Further, in example embodiments, the device may set the network coverage experience flag 342 to a predetermined value, if it is determined that the user equipment has experienced a degradation of network coverage sessions. For example, if it is determined that the user equipment has experienced a degradation of network coverage sessions, the device may set the value of the network coverage experience flag 342 to 1. Similarly, in example embodiments, if it is determined that the user equipment has not experienced a degradation of network coverage sessions, the device may set the value of the network coverage experience flag 342 to 0.

The setting of the result flags at operation S340 may enable the device to determine if the movement of the user equipment resulted in the degradation of network coverage sessions. In example embodiments, if the location change flag 341 and the network coverage experience flag 342 are both set to the value of 1, the device may determine that the movement of the user equipment resulted in the degradation of network coverage sessions.

FIG. 4 illustrates a flowchart of an example method 400 for determining a change in the location of the user equipment based on the use of a clustering algorithm, according to one or more example embodiments. One or more operations of method 400 may be at least part of operation S210 in method 200, and may be performed by the device of one or more example embodiments of the present disclosure.

As illustrated in FIG. 4, at operation S410, the device may be configured to receive user equipment location data. The user equipment location data may include geographical coordinates such as the latitude and longitude of the user equipment over a period of time. The plurality of data may also include metadata associating the geographical coordinates to the one or more user equipment.

At operation S420, the device may be configured to input the received location data from operation S410, into a clustering algorithm. The clustering algorithm may be a location-based clustering algorithm, such as DBSCAN (Density-Based Spatial Clustering of Applications with Noise) and the like. The clustering algorithm may cluster the location data into clusters based on predetermined minimum distances from each other or from a reference or predetermined point.

At operation S430, the device may obtain, as output from the clustering algorithm, a first cluster of data and a second cluster of data. The first cluster of data may be associated with a first location, and the second cluster of data may be associated with a second location different from the first location.

At operation S440, the device may be configured to determine that a value of a confidence factor product is greater than a first predetermined threshold value. The first predetermined threshold value may be predetermined by a user. Details on how the device may be configured to determine that the value of the confidence factor product is greater than a first predetermined threshold will be described in detail below with reference to FIG. 5.

At operation S450, the device may be configured to determine that a distance between a centroid of the first cluster of data and a centroid of the second cluster of data is greater than a second predetermined threshold value. The second predetermined threshold value may be predetermined by a user. Details on how the device is configured to determine that the value of the distance is greater than a second predetermined threshold value will be described in detail below with reference to FIG. 6.

In example embodiments, if the device determines at operation S440 that the value of the confidence factor product is greater than a first predetermined threshold value, and determines at operation S450 that the value of the distance between a centroid of the first cluster of data and a centroid of the second cluster of data is greater than a second predetermined threshold value, the device may determine that the user equipment has moved from a first location to a second location that is different from the first location, as described at operation S210 of example method 200 in FIG. 2 above.

FIG. 5 illustrates a flowchart of an example method 500 for determining a change in the location of the user equipment based on a first parameter associated with a location change of a user equipment, which is obtained by use of the clustering algorithm, according to one or more example embodiments. One or more operations of method 500 may be at least part of operations S430 and S440 in method 400, and may be performed by the device of one or more example embodiments of the present disclosure.

The first parameter in example method 500 may correspond to the confidence factor product described at operation S440 of example method 400 in FIG. 4 above.

Referring to FIG. 5, in example embodiments, at operation S510, the device may be configured to calculate a first confidence factor for the first cluster of data obtained at operation S430 described in example method 400 in FIG. 4 above, and calculate a second confidence factor for the second cluster of data obtained at operation S430 described in example method 400 in FIG. 4 above. The first confidence factor may correspond to a ratio of a cluster size of the first cluster of data to the total location data points, and the second confidence factor may correspond to a ratio of a cluster size of the second cluster of data to the total location data points. The method then proceeds to operation S520.

At operation S520, in example embodiments, the device may be configured to multiply the first confidence factor with the second confidence factor in order to obtain a value which may correspond to the confidence factor product described at operation S440 of example method 400 in FIG. 4 above. The method then proceeds to operation S530.

At operation S530, in example embodiments, the device may be configured to compare the confidence factor product obtained at operation S520 of method S500 in FIG. 5, with a first predetermined threshold value. The first predetermined threshold value may correspond to the first predetermined threshold value described at operation S440 of example method 400 in FIG. 4 above.

In example embodiments, based on the comparison described at operation S530 in example method 500 in FIG. 5, the device may determine that the confidence factor product is greater than the first predetermined threshold value, as described at operation S440 of example method 400 in FIG. 4 above.

FIG. 6 illustrates a diagram of an example method 600 for determining a change in the location of the user equipment based on a second parameter associated with a location change of a user equipment, which is obtained by use of the clustering algorithm, according to one or more example embodiments. One or more operations of method 600 may be part of operations S430 and S450 in method 400, and may be performed by the device of one or more example embodiments of the present disclosure.

In example embodiments, the second parameter in example method 600 may correspond to the distance between a centroid of a first cluster of data and a centroid of a second cluster of data described at operation S450 of example method 400 in FIG. 4 above.

Referring to FIG. 6, in example embodiments, at operation S610, the device may be configured to determine a centroid of the first cluster of data obtained at operation S430 described in example method 400 in FIG. 4 above, and a centroid of the second cluster of data obtained at operation S430 described in example method 400 in FIG. 4 above. By way of example, the centroid may be calculated as an average of coordinates (e.g., an average of X coordinates and an average of Y coordinates, an average of latitude coordinates and an average of longitude coordinates, etc.). The method then proceeds to operation S620.

At operation S620, the device may be configured to calculate a distance between the centroid of the first cluster of data and the centroid of the second cluster of data. The method then proceeds to operation S630.

At operation S630, in example embodiments, the device may be configured to compare the distance obtained at operation S620 of method S600 in FIG. 6, with a second predetermined threshold value. The second predetermined threshold value may correspond to the second predetermined threshold value described at operation S450 of example method 400 in FIG. 4 above.

In example embodiments, based on the comparison described at operation S630 in example method 600 in FIG. 6, the device may determine that the distance between the centroid of the first cluster of data and the centroid of the second cluster of data is greater than the second predetermined threshold value, as described at operation S450 of example method 400 in FIG. 4 above.

To this end, methods and operations of example embodiments may be implemented to provide efficiently and effectively determine if the movement of the user equipment resulted in the degradation of network coverage sessions, thereby achieving the technical advantages described hereinabove. It is contemplated that, the methods, operations, advantages, and significances described above with reference to FIGS. 2 - FIG. 6 are merely examples and the scope of the present disclosure should not be limited thereto. Specifically, one or more operations in FIGS. 2 - FIG. 6 may be performed differently, fewer or additional operations may be involved, additional advantages may be achieved, and the like, without departing from the scope of the present disclosure.

### Examples of Device

In the following, descriptions of a device in which the example embodiments may be implemented are provided. It is contemplated that one or more features, operations, and methods described above may be performed by the device upon executing machine-readable instructions or computer-readable instructions stored in a memory or a storage component of the device.

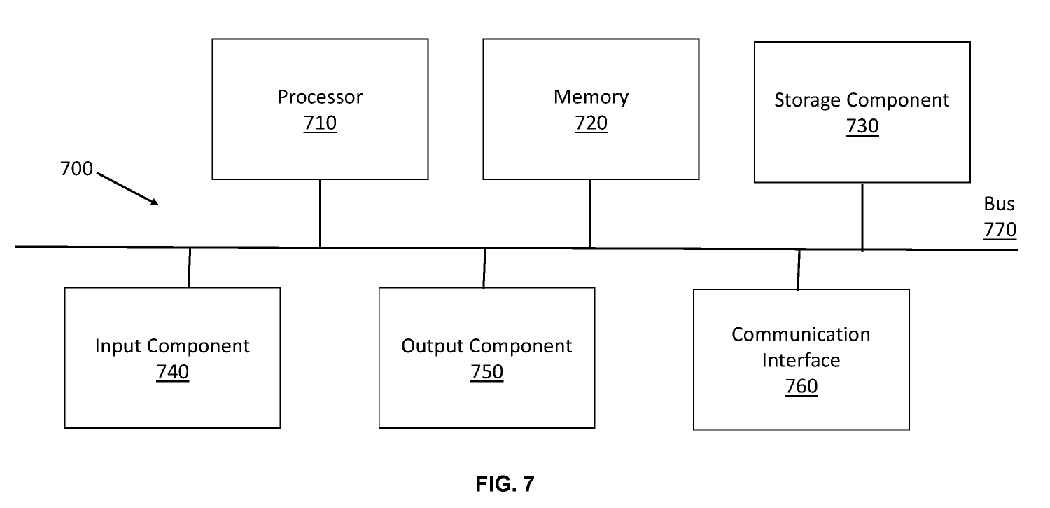

FIG. 7 illustrates an embodiment of a device 700. As shown in FIG. 7, the device 700 may include a processor 710, a memory 720, a storage component 730, an input component 740, an output component 750, a communication interface 760, and a bus 770.

The processor 710, as used herein, means any type of computational circuit that may comprise hardware elements and software elements. The processor 710 may be embodied as a multi-core processor, a single core processor, or a combination of one or more multi-core processors and/or one or more single core processors, a distributed processing system, or the like. The processor 710 may be a Central Processing Unit (CPU), a graphics processing unit (GPU), an accelerated processing unit (APU), an application-specific integrated circuit (ASIC), or another type of processing component.

Memory 720 includes a non-transitory computer readable medium. Memory 720 includes a random-access memory (RAM), a read only memory (ROM), and/or another type of dynamic or static storage device (e.g., a flash memory, a magnetic memory, and/or an optical memory) that stores information and/or instructions for use by processor 710. The memory 720 comprises machine-readable instructions which are executable by the processor 710. These machine-readable instructions when executed by the processor 710 cause the processor 710 to perform one or more method steps of an embodiment described above.

Storage component 730 stores information and/or software related to the operation and use of the device 700. For example, storage component 730 may include a hard disk (e.g., a magnetic disk, an optical disk, a magneto-optic disk, and/or a solid-state disk), a compact disc (CD), a digital versatile disc (DVD), a floppy disk, a cartridge, a magnetic tape, and/or another type of non-transitory computer-readable medium, along with a corresponding drive.

Input component 740 is configured to receive information, such as user input. For example, the input component 740 may include, but not be limited to, a touch screen display, a keyboard, a keypad, a mouse, a button, a switch, and/or a microphone. Additionally, or alternatively, the input component 740 may include a sensor for sensing information (e.g., a global positioning system (GPS), an accelerometer, a gyroscope, and/or an actuator).

Output component 750 is configured to provide output information from the device 800. For example, the output component 750 may be, but not limited to, a display, a speaker, instructions to an external device, and/or one or more light-emitting diodes (LEDs).

Communication interface 760 is an interface that provides a communication connection to other devices, such as external devices and internal devices. The connection by the communication interface 760 can be a wired connection, a wireless connection, or a combination of wired and wireless connections, and can be a direct connection or an indirect connection via a communication network that exists between the device 700 and other devices. In other words, the standard of the communication interface 760 is not limited.

The bus 770 acts as an interconnect between the processor 710, the memory 720, the storage component 730, the input component 740, the output component 750, and the communication interface 760 of the device 700. The bus 770 may include a wired interconnection or a wireless interconnection.

The number and arrangement of components shown in FIG. 7 are provided as an example. In practice, device 700 may include additional components, fewer components, different components, or differently arranged components than those shown in FIG. 7. Additionally, or alternatively, a set of components (e.g., one or more components) of device 700 may perform one or more functions described as being performed by another set of components of device 700. Further, one or more method steps described in any of the embodiments may be performed utilizing a plurality of devices 700 in communication with one another.

### Examples Implementation Environment

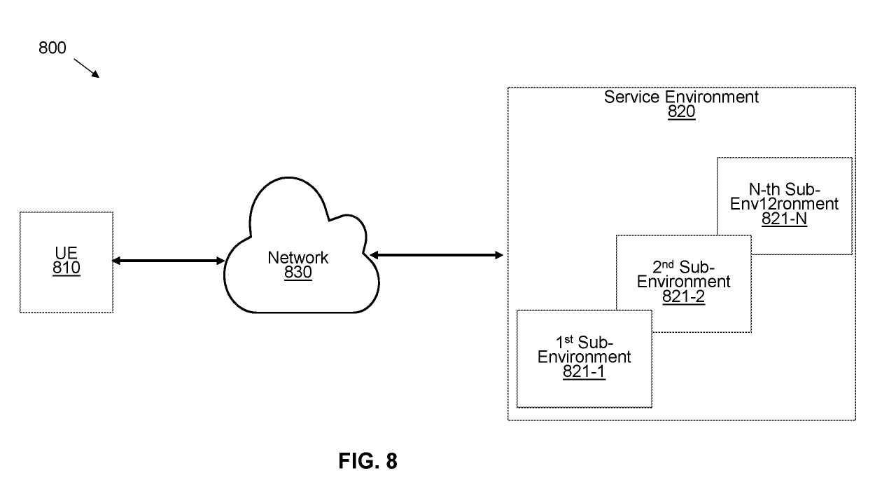

FIG. 8 illustrates a diagram of an example environment 800 in which systems and/or method, described herein, may be implemented. The implementation environment 800 includes a UE (User equipment) 810, a service environment 820, and a network 830. The service environment 820 includes one or more sub-environments 821. To illustrate this, FIG. 8 shows, for convenience, examples of a 1st sub-environment 821-1, a 2nd sub-environment 821-2, and an N-th sub-environment 821-N (where N is any natural number).

The UE 810 is connected to the network 830, and the network 830 is connected to the service environment 820. The connections may be wired, wireless, or a combination of both wired and wireless. The UE 810 and the service environment 820 are connected via the network 830.

The UE 810 is a device that communicates with the service environment 820. The UE 810 receives information from the service environment 820 and/or sends information to the service environment 820. Also, the UE 810 may generate and/or store information to be transmitted, as necessary. Also, the UE 810 may store and/or process information that is received, as necessary.

The example FIG. 8 refers to the “UE”. However, it should be understood by those skilled in the art that general terms such as “user device,” “terminal,” “terminal device,” “communication device,” and “communication terminal” can be used interchangeably with the term “UE.”

For example, the UE 810 may include a computing device (e.g., a desktop computer, a laptop computer, a tablet computer, a handheld computer, a smart speaker, a server, etc.), a mobile phone (e.g., a smart phone, a radiotelephone, etc.), a wearable device (e.g., a pair of smart glasses or a smart watch), or a similar device.

The service environment 820 is an environment that communicates with the UE 810 to provide one or more services. The service environment 820 receives information from the UE 810 and/or sends information to the UE 810. Also, the service environment 820 may generate and/or store information to be transmitted, as necessary. Also, the service environment 820 may store and/or process information that is received, as necessary. For example, the service environment 820 may provide computing resources as one of the services. It should be noted that the service is not limited to being provided to the UE; it may also be provided to devices other than the UE. For example, based on communication from the UE, the service may perform processes such as anomaly detection or traffic analysis and notify the results to a predetermined destination.

The example FIG. 8 refers to the “service environment”. The term "service environment" is used to refer to the broader context within which services operate. For example, cloud environments, platforms, computing systems, network systems, and cloud systems generally represent the environments in which services are conducted, and these are included within the "service environment." However, the "service environment" is not limited to these examples. Additionally, the specific types of environments within the "service environment" are not restricted. For instance, cloud environments and cloud systems can be categorized as private cloud, public cloud, hybrid cloud, or multi-cloud, all of which are included within the "service environment."

The one or more services provided by the service environment 820 is not specifically limited and can be adjusted according to the embodiments. For example, the services may include a service that provides information to the UE 810, a service that stores information from the UE 810, or a service that performs processing based on information from the UE 810 and returns the results of the processing.

In an embodiment, the Service Environments 820 may also provide computing resources as the service. The computing resources can be hardware resources and/or software resources. For example, applications, processors, memory, and storage can be included in the provided computing resources. Each computing resource can communicate with other computing resources via wired connections, wireless connections, or a combination of wired and wireless connections.

The provided computing resources can be actual resources (also referred to as physical resources) and/or virtual resources. Furthermore, means of virtualization for virtual resources can be selected as appropriate. That is, in this disclosure, the use of adjectives such as "Virtual" or "Virtualized" to describe names does not imply that they are virtualized by a specific means of virtualization. For example, “virtual machine” refers to software that operates like an actual computer, realized through means of virtualization, and it is not intended to exclude those realized by specific means of virtualization such as Hypervisors or Containers. Conversely, when means of virtualization such as Hypervisors or containers are mentioned in this disclosure, it is merely cited as a general method of implementation. It should also be interpreted that embodiments implemented with other virtualization means are also disclosed. Also, the services may also be provided using resources virtualized by different means.

The service environment 820 includes one or more devices, such as servers and network devices, which provide services or perform processes. The placement of these devices within the service environment 820 can be determined as appropriate. Additionally, if the service environment 820 includes one or more sub-environments 821, the placement of devices can be determined based on predetermined policies for each sub-environment 821. For example, devices related to the first service may be placed in the 1st sub-environment 821-1, and devices related to the second service may be placed in the 2nd sub-environment 821-2. In another example, devices expected to have a higher load than a predetermined threshold may be placed in the 1st sub-environment 821-1, while devices expected to have a lower load than the predetermined threshold may be placed in the 2nd sub-environment 821-2. In this way, specific devices can be placed in specific sub-environments 821. Conversely, each sub-environment 821 can be specialized for a particular purpose.

In an embodiment, all processes executed in a single service may run within a single service environment, or in multiple service environments. Multiple processes executed in a single service could be provided by different service environments.

The network 830 is a network that exchanges information between the UE 810 and the service environment 820. The network 830 includes one or more wired and/or wireless networks.

For example, the network 830 may include a cellular network (e.g., a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, or the like, a non-terrestrial network (NTN), and/or a combination of these or other types of networks.

The network 830 can be a part of a network. For example, in a 5G network that includes a RAN, a transport network, and a core network, the network 830 can be at least one of the RAN, the transport network, or the core network. For example, the service environment 820 could be in the core network, in which case the network 830 could correspond to a network that is a combination of a RAN and a transport network and is part of the 5G network.

The number and arrangement of devices and networks shown in FIG. 8 are provided as an example. It should be understood that any changes that may be implemented by those skilled in the art, such as the addition or rearrangement of well-known devices or networks at the time of implementation, are included in this disclosure.

### Various Aspects of Embodiments

It is contemplated that features, advantages, and significances of example embodiments described hereinabove are merely examples of the present disclosure, and are not intended to be exhaustive or to limit the scope of the present disclosure.

Specifically, the foregoing disclosure provides illustration and description, but is not intended to be exhaustive or to limit the implementations to the precise form disclosed. Modifications and variations are possible in light of the above disclosure or may be acquired from practice of the implementations.

Some embodiments may relate to a device, a system, a method, and/or a computer-readable medium at any possible technical detail level of integration. Further, one or more of the above components described above may be implemented as instructions stored on a computer-readable medium and executable by at least one processor (and/or may include at least one processor). The computer-readable medium may include a computer-readable non-transitory storage medium (or media) having computer-readable program instructions thereon for causing a processor to carry out operations.

The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), electrically erasable programmable read-only memory (EEPROM), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer-readable program instructions from the network and forwards the computer-readable program instructions for storage in a computer-readable storage medium within the respective computing/processing device.

Computer-readable program code/instructions for carrying out operations may be assembler instructions, instruction-set-architecture (ISA) instructions, machine instructions, machine-dependent instructions, microcode, firmware instructions, state-setting data, configuration data for integrated circuitry, or either source code or object code written in any combination of one or more programming languages, including an object-oriented programming language such as Smalltalk, C++, or the like, and procedural programming languages, such as the "C" programming language or similar programming languages.

The computer-readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer-readable program instructions by utilizing state information of the computer-readable program instructions to personalize the electronic circuitry, in order to perform aspects or operations.

These computer-readable program instructions may be provided to a processor of a general-purpose computer, special-purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer-readable program instructions may also be loaded onto a computer, other programmable data processing apparatus, or other devices to cause a series of operational steps to be performed on the computer, other programmable apparatus or other devices to produce a computer-implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer-readable media according to various embodiments. In this regard, each block in the flowchart or block diagrams may represent a module, segment, or portion of instructions, which comprises one or more executable instructions for implementing the specified logical function(s). The method, computer system, and computer-readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limited to the implementations. Thus, the operation and behavior of the systems and/or methods were described herein without reference to specific software code—it is understood that software and hardware may be designed to implement the systems and/or methods based on the description herein.

In view of the above, various further respective aspects and features of embodiments of the present disclosure may be defined by the following items:

Item [1]: A device configured to:
determine, based on at least one parameter associated with a location change of a user equipment (UE), that the UE has moved from a first location to a second location that is different from the first location;
determine, based on at least one parameter associated with a strength of a signal received by the UE, that the UE has experienced a degradation of network coverage sessions; and
based on determining that the UE has moved and that the UE has experienced the degradation of network coverage sessions, determine that the movement of the UE resulted in the degradation of network coverage sessions.

Item [2]: The device according to Item [1], wherein the at least one parameter associated with the location change of the UE comprises a confidence factor product and a distance between a centroid of a first cluster of data and a centroid of a second cluster of data.

Item [3]: The device according to Items [1]-[2], wherein the device is configured to determine that the UE has moved from the first location to the second location by:
receiving location data of the UE;
inputting the location data into a clustering algorithm;
obtaining at least two clusters of data outputted by the clustering algorithm, wherein the at least two clusters of data comprises the first cluster of data and the second cluster of data;
determining that a value of a confidence factor product is greater than a first predetermined threshold; and
determining that a value of a distance between a centroid of a first cluster of data and a centroid of a second cluster of data is greater than a second predetermined threshold.

Item [4]: The device according to Item [3], wherein the device is configured to determine that the value of the confidence factor product is greater than the first predetermined threshold by:
calculating a first confidence factor for the first cluster of data and a second confidence factor for the second cluster of data;
multiplying the first confidence factor and the second confidence factor to obtain the value of the confidence factor product; and
comparing the value of the confidence factor product with the first predetermined threshold.

Item [5]: The device according to Item [3], wherein the device is configured to determine that the value of the distance is greater than the second predetermined threshold by:
determining the centroid of the first cluster of data and the centroid of the second cluster of data;
calculating the value of the distance between the centroid of the first cluster of data and the centroid of the second cluster of data; and
comparing the value of the distance with the second predetermined threshold.

Item [6]: The device according to Items [1]-[5], wherein the at least one parameter associated with the strength of the signal received by the UE comprises a first percentage of sessions where the signal strength is below -116dBm when the UE is at the first location, and, a second percentage of sessions where the strength of the signal received is below -116dBm when the UE is at the second location.

Item [7]: The device according to Item [6], wherein the device is configured to determine that the UE has experienced a degradation of network coverage sessions by:
determining that the second percentage is greater than the first percentage.

Item [8]: A method comprising: determining,
based on at least one parameter associated with a location change of a user equipment (UE), that the UE has moved from a first location to a second location that is different from the first location;
determining, based on at least one parameter associated with a strength of a signal received by the UE, that the UE has experienced a degradation of network coverage sessions; and
on determining that the UE has moved and that the UE has experienced the degradation of network coverage sessions, determining that the movement of the UE resulted in the degradation of network coverage sessions.

Item [9]: The method according to Item [8], wherein the at least one parameter associated with the location change of the UE comprises a confidence factor product and a distance between a centroid of a first cluster of data and a centroid of a second cluster of data.

Item [10]: The method according to Items [8]-[9], wherein determining that the UE has moved from the first location to the second location comprises:
receiving location data of the UE;
inputting the location data into a clustering algorithm;
obtaining at least two clusters of data outputted by the clustering algorithm, wherein the at least two clusters of data comprises the first cluster of data and the second cluster of data;
determining that a value of a confidence factor product is greater than a first predetermined threshold; and
determining that a value of a distance between a centroid of a first cluster of data and a centroid of a second cluster of data is greater than a second predetermined threshold.

Item [11]: The method according to Item [10], wherein determining that the value of the confidence factor product is greater than the first predetermined threshold comprises:
calculating a first confidence factor for the first cluster of data and a second confidence factor for the second cluster of data;
multiplying the first confidence factor and the second confidence factor to obtain the value of the confidence factor product; and
comparing the value of the confidence factor product with the first predetermined threshold.

Item [12]: The method according to Item [10], wherein determining that the value of the distance is greater than the second predetermined threshold comprises:
determining the centroid of the first cluster of data and the centroid of the second cluster of data;
calculating the value of the distance between the centroid of the first cluster of data and the centroid of the second cluster of data; and
comparing the value of the distance with the second predetermined threshold.

Item [13]: The method according to Items [8]-[12], wherein the at least one parameter associated with the strength of the signal received by the UE comprises a first percentage of sessions where the signal strength is below -116dBm when the UE is at the first location, and, a second percentage of sessions where the strength of the signal received is below -116dBm when the UE is at the second location.

Item [14]: The method according to Item [13], wherein the device is configured to determine that the UE has experienced a degradation of network coverage sessions by:
that the second percentage is greater than the first percentage.

Item [15]: A non-transitory computer-readable recording medium having recorded thereon instructions executable by a device to cause the device to perform a method comprising:
determining, based on at least one parameter associated with a location change of a user equipment (UE), that the UE has moved from a first location to a second location that is different from the first location;
determining, based on at least one parameter associated with a strength of a signal received by the UE, that the UE has experienced a degradation of network coverage sessions; and
based on determining that the UE has moved and that the UE has experienced the degradation of network coverage sessions, determining that the movement of the UE resulted in the degradation of network coverage sessions.

Item [16]: The non-transitory computer-readable recording medium according to Item [15], wherein the at least one parameter associated with the location change of the UE comprises a confidence factor product and a distance between a centroid of a first cluster of data and a centroid of a second cluster of data.

Item [17]: The non-transitory computer-readable recording medium according to Items [15]-[16], wherein determining that the UE has moved from the first location to the second location comprises:
receiving location data of the UE;
inputting the location data into a clustering algorithm;
obtaining at least two clusters of data outputted by the clustering algorithm, wherein the at least two clusters of data comprises the first cluster of data and the second cluster of data;
determining that a value of a confidence factor product is greater than a first predetermined threshold; and
determining that a value of a distance between a centroid of a first cluster of data and a centroid of a second cluster of data is greater than a second predetermined threshold.

Item [18]: The non-transitory computer-readable recording medium according to Item [17], wherein determining that the value of the confidence factor product is greater than the first predetermined threshold comprises:
calculating a first confidence factor for the first cluster of data and a second confidence factor for the second cluster of data;
multiplying the first confidence factor and the second confidence factor to obtain the value of the confidence factor product; and
comparing the confidence factor product with the first predetermined threshold.

Item [19]: The non-transitory computer-readable recording medium according to Item [17],wherein determining that the value of the distance is greater than a second predetermined threshold comprises:
determining the centroid of the first cluster of data and the centroid of the second cluster of data;
calculating the value of the distance between the centroid of the first cluster of data and the centroid of the second cluster of data; and
comparing the value of the distance to the second predetermined threshold.

Item [20]: The non-transitory computer-readable recording medium according to Items [15]-[19], wherein the at least one parameter associated with the strength of the signal received by the UE comprises a first percentage of sessions where the signal strength is below -116dBm when the UE is at the first location, and, a second percentage of sessions where the strength of the signal received is below -116dBm when the UE is at the second location.

It can be understood that numerous modifications and variations of the present disclosure are possible in light of the above teachings. It will be apparent that within the scope of the appended clauses, the present disclosures may be practiced otherwise than as specifically described herein.

What is claimed is:

1. A device configured to:
determine, based on at least one parameter associated with a location change of a user equipment (UE), that the UE has moved from a first location to a second location that is different from the first location;
determine, based on at least one parameter associated with a strength of a signal received by the UE, that the UE has experienced a degradation of network coverage sessions; and
based on determining that the UE has moved and that the UE has experienced the degradation of network coverage sessions, determine that the movement of the UE resulted in the degradation of network coverage sessions.

2. The device according to claim 1, wherein the at least one parameter associated with the location change of the UE comprises a confidence factor product and a distance between a centroid of a first cluster of data and a centroid of a second cluster of data.

3. The device according to claim 1, wherein the device is configured to determine that the UE has moved from the first location to the second location by:
receiving location data of the UE;
inputting the location data into a clustering algorithm;
obtaining at least two clusters of data outputted by the clustering algorithm, wherein the at least two clusters of data comprises a first cluster of data and a second cluster of data;
determining that a value of a confidence factor product is greater than a first predetermined threshold; and
determining that a value of a distance between a centroid of a first cluster of data and a centroid of a second cluster of data is greater than a second predetermined threshold.

4. The device according to claim 3, wherein the device is configured to determine that the value of the confidence factor product is greater than the first predetermined threshold by:
calculating a first confidence factor for the first cluster of data and a second confidence factor for the second cluster of data;
multiplying the first confidence factor and the second confidence factor to obtain the value of the confidence factor product; and
comparing the value of the confidence factor product with the first predetermined threshold.

5. The device according to claim 3, wherein the device is configured to determine that the value of the distance is greater than the second predetermined threshold by:
determining the centroid of the first cluster of data and the centroid of the second cluster of data;
calculating the value of the distance between the centroid of the first cluster of data and the centroid of the second cluster of data; and
comparing the value of the distance with the second predetermined threshold.

6. The device according to claim 1, wherein the at least one parameter associated with the strength of the signal received by the UE comprises a first percentage of sessions where the strength of the signal is below -116dBm when the UE is at the first location, and, a second percentage of sessions where the strength of the signal received is below -116dBm when the UE is at the second location.

7. The device according to claim 6, wherein the device is configured to determine that the UE has experienced a degradation of network coverage sessions by:
determining that the second percentage is greater than the first percentage.

8. A method comprising:
determining, based on at least one parameter associated with a location change of a user equipment (UE), that the UE has moved from a first location to a second location that is different from the first location;
determining, based on at least one parameter associated with a strength of a signal received by the UE, that the UE has experienced a degradation of network coverage sessions; and
based on determining that the UE has moved and that the UE has experienced the degradation of network coverage sessions, determining that the movement of the UE resulted in the degradation of network coverage sessions.

9. The method according to claim 8, wherein the at least one parameter associated with the location change of the UE comprises a confidence factor product and a distance between a centroid of a first cluster of data and a centroid of a second cluster of data.

10. The method according to claim 8, wherein determining that the UE has moved from the first location to the second location comprises:
receiving location data of the UE;
inputting the location data into a clustering algorithm;
obtaining at least two clusters of data outputted by the clustering algorithm, wherein the at least two clusters of data comprises the first cluster of data and the second cluster of data;
determining that a value of a confidence factor product is greater than a first predetermined threshold; and
determining that a value of a distance between a centroid of a first cluster of data and a centroid of a second cluster of data is greater than a second predetermined threshold.

11. The method according to claim 10, wherein determining that the value of the confidence factor product is greater than the first predetermined threshold comprises:
calculating a first confidence factor for the first cluster of data and a second confidence factor for the second cluster of data;
multiplying the first confidence factor and the second confidence factor to obtain the value of the confidence factor product; and
comparing the value of the confidence factor product with the first predetermined threshold.

12. The method according to claim 10, wherein determining that the value of the distance is greater than the second predetermined threshold comprises:
determining the centroid of the first cluster of data and the centroid of the second cluster of data;
calculating the value of the distance between the centroid of the first cluster of data and the centroid of the second cluster of data; and
comparing the value of the distance with the second predetermined threshold.

13. The method according to claim 8, wherein the at least one parameter associated with the strength of the signal received by the UE comprises a first percentage of sessions where the strength of the signal is below -116dBm when the UE is at the first location, and a second percentage of sessions where the strength of the signal received is below -116dBm when the UE is at the second location.

14. The method according to claim 13, wherein the device is configured to determine that the UE has experienced a degradation of network coverage sessions by:
determining that the second percentage is greater than the first percentage.

15. A non-transitory computer-readable recording medium having recorded thereon instructions executable by a device to cause the device to perform a method comprising:
determining, based on at least one parameter associated with a location change of a user equipment (UE), that the UE has moved from a first location to a second location that is different from the first location;
determining, based on at least one parameter associated with a strength of a signal received by the UE, that the UE has experienced a degradation of network coverage sessions; and
based on determining that the UE has moved and that the UE has experienced the degradation of network coverage sessions, determining that the movement of the UE resulted in the degradation of network coverage sessions.

16. The non-transitory computer-readable recording medium according to claim 15, wherein the at least one parameter associated with the location change of the UE comprises a confidence factor product and a distance between a centroid of a first cluster of data and a centroid of a second cluster of data.

17. The non-transitory computer-readable recording medium according to claim 15, wherein determining that the UE has moved from the first location to the second location comprises:
receiving location data of the UE;
inputting the location data into a clustering algorithm;
obtaining at least two clusters of data outputted by the clustering algorithm, wherein the at least two clusters of data comprises the first cluster of data and the second cluster of data;
determining that a value of a confidence factor product is greater than a first predetermined threshold; and
determining that a value of a distance between a centroid of a first cluster of data and a centroid of a second cluster of data is greater than a second predetermined threshold.

18. The non-transitory computer-readable recording medium according to claim 17, wherein determining that the value of the confidence factor product is greater than the first predetermined threshold comprises:
calculating a first confidence factor for the first cluster of data and a second confidence factor for the second cluster of data;
multiplying the first confidence factor and the second confidence factor to obtain the value of the confidence factor product; and
comparing the confidence factor product with the first predetermined threshold.

19. The non-transitory computer-readable recording medium according to claim 17,wherein determining that the value of the distance is greater than a second predetermined threshold comprises:
determining the centroid of the first cluster of data and the centroid of the second cluster of data;
calculating the value of the distance between the centroid of the first cluster of data and the centroid of the second cluster of data; and
comparing the value of the distance to the second predetermined threshold.

20. The non-transitory computer-readable recording medium according to claim 15, wherein the at least one parameter associated with the strength of the signal received by the UE comprises a first percentage of sessions where the strength of the signal is below -116dBm when the UE is at the first location, and a second percentage of sessions where the strength of the signal received is below -116dBm when the UE is at the second location.
